(19) United States
(12) Patent Application Publication
(10) Pub. No.: US 2026/0316910 A1
(43) Pub. Date: Oct. 15, 2026

(54) Underwater Apparatus with Detachable Battery Compartment

(71) Applicant: Dongguan Miles Precision Manufacturing Co., Ltd., Dongguan (CN)

(72) Inventors: Jun Ouyang, Dongguan (CN); Zaiyuan Peng, Dongguan (CN)

(21) Appl. No.: 19/220,035

(22) Filed: May 27, 2025

(30) Foreign Application Priority Data
Apr. 14, 2025 (CN) 202510467623.8
Apr. 14, 2025 (CN) 202520703889.3

(51) Int. Cl. B63C 11/52; B63C 11/02

(52) U.S. Cl. CPC B63C 11/52; B63C 2011/027

(57) ABSTRACT

An underwater apparatus with a detachable battery compartment includes: a battery compartment mechanism; a functional apparatus; a first connecting base fixed on the battery compartment mechanism and electrically connected to the battery compartment mechanism; a second connecting base fixed on the functional apparatus and electrically connected to the functional apparatus; and a locking mechanism, wherein the battery compartment mechanism is detachably provided outside the functional apparatus via the locking mechanism, and the first connecting base and the second connecting base are detachably electrically connected. In the present application, the battery compartment mechanism is independently provided outside the functional apparatus, and when the two are assembled, the physical connection is completed by the locking mechanism, and the electrical connection is completed by the cooperation of the first connecting base and the second connecting base, so that the battery compartment mechanism can stably supply power to the functional apparatus.

### CROSS REFERENCE TO RELATED APPLICATIONS

The present application claims the benefit of Chinese Patent Application Nos. 202510467623.8 and 202520703889.3 filed on Apr. 14, 2025. All the above are hereby incorporated by reference in their entirety.

### TECHNICAL FIELD

The present application belongs to the field of electrical equipment and in particular relates to an underwater apparatus with a detachable battery compartment.

### BACKGROUND ART

With the continuous development of underwater operations, marine resource exploration, underwater scientific research, underwater recreation and other fields, the application of various underwater apparatus has become increasingly widespread. These underwater devices typically rely on batteries as their power supply to ensure normal operation in underwater environments.

However, traditional underwater apparatus often has certain limitations in design. In most cases, the battery compartment and the device mainboard are integrated within the same cavity. Although this design approach simplifies the equipment structure and assembly process to some extent, it exposes numerous problems during actual use.

On one hand, since the battery and the mainboard share the same cavity, when one component fails or is damaged, it easily affects other components. For example, if the battery experiences leakage or other failures, it may cause corrosion and damage to the electronic components on the device mainboard; conversely, if the mainboard malfunctions, replacing it may negatively impact the battery and its connecting circuits, potentially even leading to safety accidents due to improper operations.

On the other hand, in some complex underwater working environments such as deep-sea exploration or long-term underwater monitoring missions, the reliability and stability of the equipment are crucial. The traditional integrated design has low fault tolerance when facing harsh conditions, once a critical component fails, the entire apparatus may become inoperable, requiring complex repairs or complete replacement, which not only hinders task progression but may also result in significant data loss and economic losses.

Additionally, for underwater apparatus requiring prolonged continuous operation, battery endurance remains a pressing issue. In traditional designs, since the battery shares the same cavity with the mainboard, battery capacity and replacement convenience are restricted, making it difficult to meet long-term operational demands.

Therefore, designing a more rational, reliable, and maintenance-friendly underwater apparatus structure with easily replaceable components has become a technical problem urgently needing resolution by a person skilled in the art.

### SUMMARY OF THE INVENTION

In order to solve the above-mentioned problems, it is an objective of the present application to provide an underwater apparatus with a detachable battery compartment having a detachable battery compartment mechanism, which is more secure and reliable, and which is easy to maintain and replace parts.

In order to achieve the above objective, the technical solution of the present application is as follows:
an underwater apparatus with a detachable battery compartment including:
a battery compartment mechanism;
a functional apparatus;
a first connecting base fixed on the battery compartment mechanism and electrically connected to the battery compartment mechanism;
a second connecting base fixed on the functional apparatus and electrically connected to the functional apparatus; and
a locking mechanism, where the battery compartment mechanism is detachably provided outside the functional apparatus via the locking mechanism, and the first connecting base and the second connecting base are detachably electrically connected.

In the underwater apparatus, the battery compartment mechanism is independently provided outside the functional apparatus, and when the two are assembled, the physical connection is completed by the locking mechanism, and the electrical connection is completed by the cooperation of the first connecting base and the second connecting base, so that the battery compartment mechanism can stably supply power to the functional apparatus.

Further, the locking mechanism includes a first locking member and a second locking member, the first locking member is fixedly provided outside the functional apparatus, at least one end of the second locking member is detachably connected or movably connected to the first locking member, and a locking position for locking the battery compartment mechanism is formed between the second locking member and the first locking member.

Further, the second locking member has one end hinged to one end of the first locking member and has the other end detachably connected to the other end of the first locking member, and the locking position is a locking cavity for surrounding the battery compartment mechanism.

Further, the second locking member has one end detachably connected to one end of the first locking member and has the other end detachably connected to the other end of the first locking member, and the locking position is a locking cavity for surrounding the battery compartment mechanism.

Further, the first connecting base is bent and fixed at a lower end of the battery compartment mechanism, and an upper end or a middle part of the battery compartment mechanism is detachably provided outside the functional apparatus via the locking mechanism.

Further, the first connecting base includes a first connector and an insulated first water barrier, the first connector is fixedly provided on the battery compartment mechanism, the first connector has one end protrude out of the battery compartment mechanism to form a first connecting terminal and the other end extend into the battery compartment mechanism to form a first equipment terminal electrically connected to the battery compartment mechanism, the first water barrier is fixedly provided outside the battery compartment mechanism, and the first water barrier surrounds the first connecting terminal;
the second connecting base includes a second connector and an insulated second water barrier, the second connector is fixedly provided on the functional apparatus, has one end protrude out of the functional apparatus to form a second connecting terminal and has the other end extend into the functional apparatus to form a second equipment terminal electrically connected to the functional apparatus, the second water barrier is fixedly provided outside the functional apparatus, and the second water barrier surrounds the second connecting terminal; and the first water barrier is detachably sleeved outside the second water barrier, or the second water barrier is detachably sleeved outside the first water barrier; and the first connecting terminal is detachably and electrically connected to the second connecting terminal.

Further, the underwater apparatus further includes a first waterproof ring, where the first waterproof ring is sleeved outside the second water barrier, and the inner side of the first water barrier abuts against the first waterproof ring; and

a first waterproof groove is provided around the outside of the second water barrier, and the first waterproof ring is sleeved in the first waterproof groove and protrudes outside the second water barrier.

Further, the first connecting base further includes a first insulating sleeve, the battery compartment mechanism is provided with a first mounting hole into which the first connector is provided, the first insulating sleeve is sleeved inside and attached to the first connector, and the first insulating sleeve is attached outside at a side face of the first mounting hole;

a second waterproof groove is provided outside the first insulating sleeve, a second waterproof ring is sleeved in the second waterproof groove, and the second waterproof ring abuts against a side face of the first mounting hole; and

a third waterproof ring is sleeved on the first connector and abuts against an inner side of the first insulating sleeve.

Further, the first connector is movably connected to the first insulating sleeve, a rebound chamber is provided at one end of the first insulating sleeve close to the first connecting terminal, a first abutting ring is fixed outside the first connecting terminal, a first spring is also provided in the rebound chamber and is sleeved at the first connecting terminal, and two ends of the first spring respectively abut against or are connected to the first abutting ring and the first insulating sleeve.

Further, the second connecting base further includes a second insulating sleeve, the functional apparatus is provided with a second mounting hole into which the second connector is provided, the second insulating sleeve is sleeved inside and attached to the second connector, and the second insulating sleeve is attached outside at a side face of the second mounting hole;

a third waterproof groove is provided outside the second insulating sleeve, a fourth waterproof ring is sleeved in the third waterproof groove, and the fourth waterproof ring abuts against the side face of the second mounting hole.

a fourth waterproof groove is sleeved on the second connector, a fifth waterproof ring is sleeved in the fourth waterproof groove, and the fifth waterproof ring abuts against an inner side of the second insulating sleeve.

Further, the battery compartment mechanism includes a battery compartment body and a connecting base body, a battery assembly is provided in the battery compartment body, an electrical contact surface is formed at a lower end of the battery compartment body, and a battery electrical contact terminal electrically connected to the battery assembly is provided at the electrical contact surface;

the connecting base body is provided with an electrical contact slot, the first connector and the first water barrier are both fixedly provided on the connecting base body, the first connecting terminal protrudes outside the connecting base body, and the first equipment terminal extends into the electrical contact slot; and

the connecting base body is provided with an electrical contact port connected to the electrical contact slot, the connecting base body is detachably connected to the lower end of the battery compartment mechanism, the electrical contact surface abuts against the electrical contact port so as to close the electrical contact port, and the first equipment terminal is electrically connected to the battery electrical contact terminal.

In the present application, there are the following advantageous effects:
1. The battery compartment mechanism and functional apparatus are relatively independent, which can avoid mutual influence in use, and effectively improve the safety of the underwater apparatus;
2. The battery compartment mechanism and the functional apparatus can be separated according to needs, so as to be more convenient when the battery compartment mechanism or the functional apparatus is maintained, overhauled and replaced; and
3. A larger capacity battery compartment mechanism may be selected or replaced as needed so that the endurance of the underwater apparatus is not limited by the size of the functional apparatus.

### BRIEF DESCRIPTION OF THE DRAWINGS

FIG. 1 is a cross-sectional view according to the present application.

FIG. 2 is a partial sectional view showing a structure of a first connecting base, a second connecting base, a first insulating sleeve, and a second insulating sleeve according to the present application.

FIG. 3 is a schematic structural diagram showing a battery compartment mechanism.

FIG. 4 is a schematic structural diagram showing a functional apparatus.

FIG. 5 is a schematic structural diagram showing a battery compartment body.

FIG. 6 is a schematic structural diagram showing a connecting base body.

FIG. 7 is a schematic structural diagram showing a configuration in which a functional apparatus is a camera diving housing.

FIG. 8 is a schematic structural diagram showing a configuration in which a functional apparatus is a monitor body housing.

FIG. 9 is a schematic structural diagram showing a configuration in which a functional apparatus is a video light.

FIG. 10 is a schematic structural diagram showing a configuration in which a functional apparatus is a flash light.

FIG. 11 is a schematic structural diagram showing a locking mechanism of a first embodiment.

FIG. 12 is a schematic structural diagram showing a locking mechanism of a second embodiment.

### REFERENCE NUMERALS

1. first connecting base; 11. first connector; 111. first connecting terminal; 112. first equipment terminal; 113. abutting ring; 12. first water barrier;
2. second connecting base; 21. second connector; 211. second connecting terminal; 212. second equipment terminal; 213. fourth waterproof groove; 22. second water barrier; 221. first waterproof groove;
3. battery compartment mechanism; 31. first mounting hole; 32. battery compartment body; 321. battery assembly; 322. electrical contact surface; 3221. fifth waterproof groove; 323. battery electrical contact terminal; 33. connecting base body; 331. electrical contact slot; 3311. trigger; 332. electrical contact port; 34. sixth waterproof ring;
4. functional apparatus; 41. second mounting hole;
5. first waterproof ring;
6. first insulating sleeve; 61. second waterproof groove; 62. second waterproof ring; 63. third waterproof ring; 64. rebound chamber; 65. first spring; 66. moveable piece;
7. second insulating sleeve; 71. third waterproof groove; 72. fourth waterproof ring; 73. fifth waterproof ring;
8. locking mechanism (first embodiment); 81. first locking member; 82. second locking member; 83. locking cavity;
9. locking mechanism (second embodiment); 91. first locking member; 911. buckle bracket; 92. second locking member; 93. locking cavity; 94. buckle assembly; 941. buckle member; 942. second spring.

### DETAILED DESCRIPTION OF THE INVENTION

In order that the objects, aspects and advantages of the present application will become more apparent, a more particular description of the invention will be rendered by reference to the embodiments thereof which are illustrated in the appended drawings. It should be understood that the particular embodiments described herein are illustrative only and are not limiting.

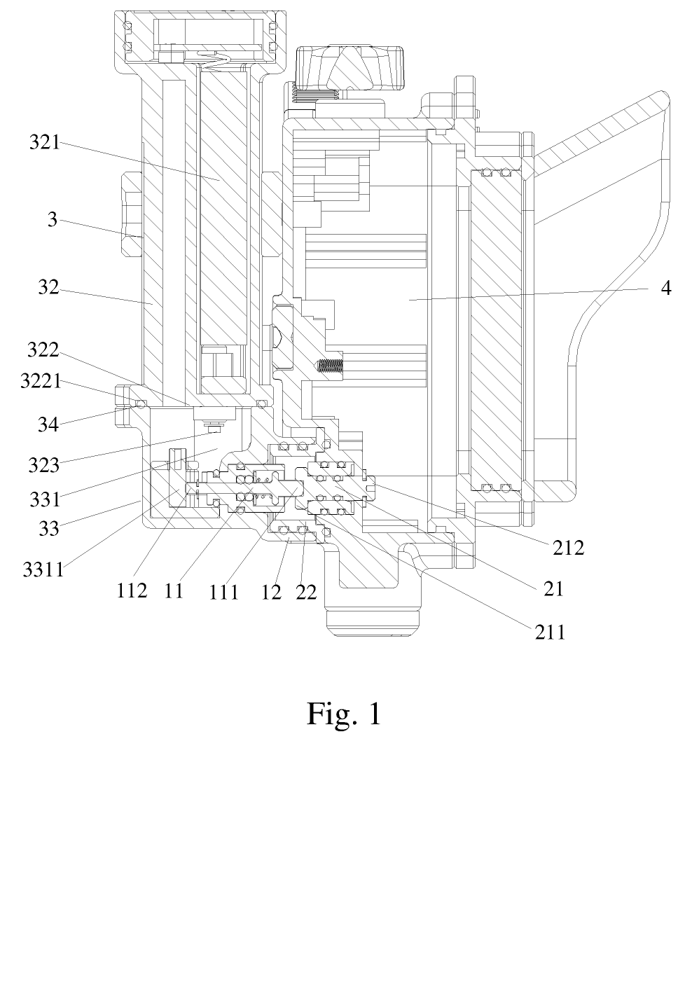

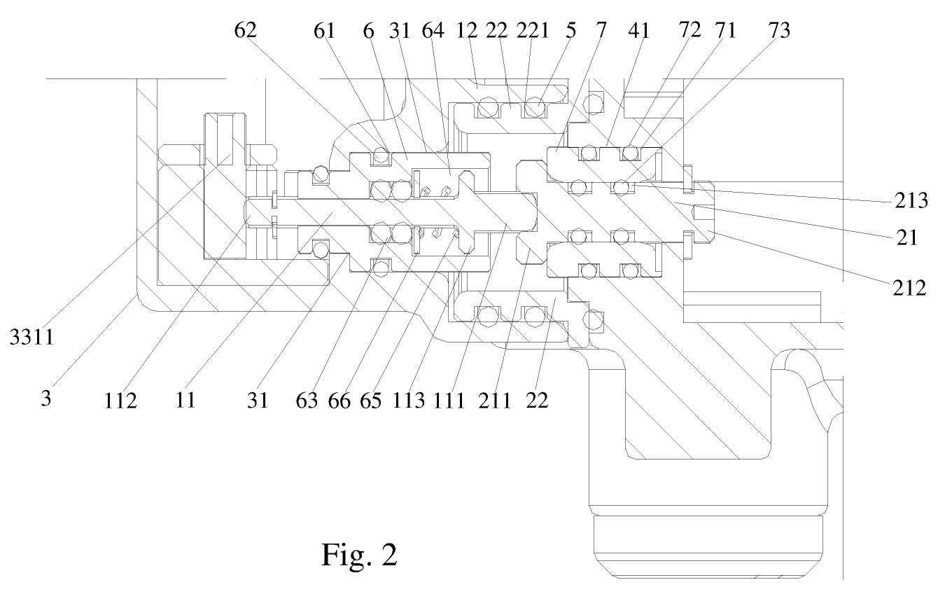

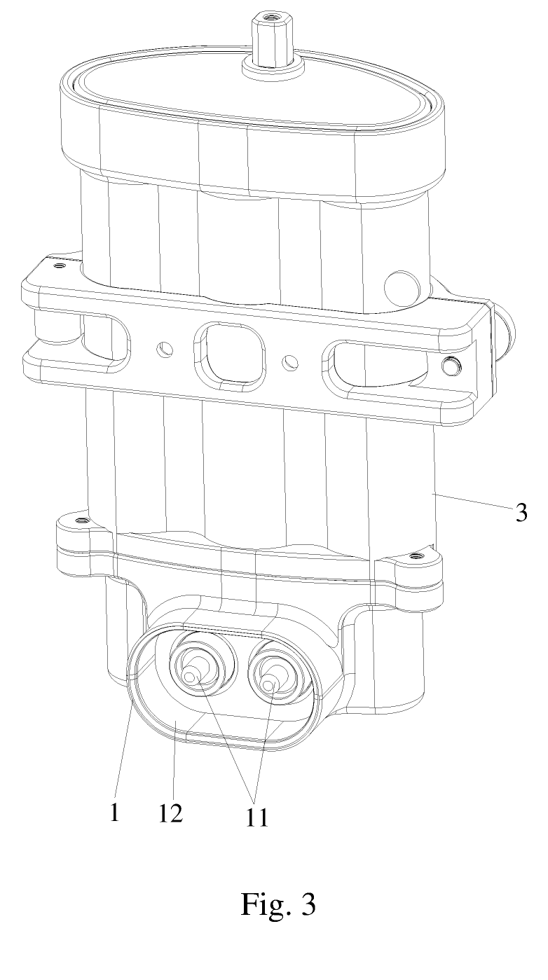

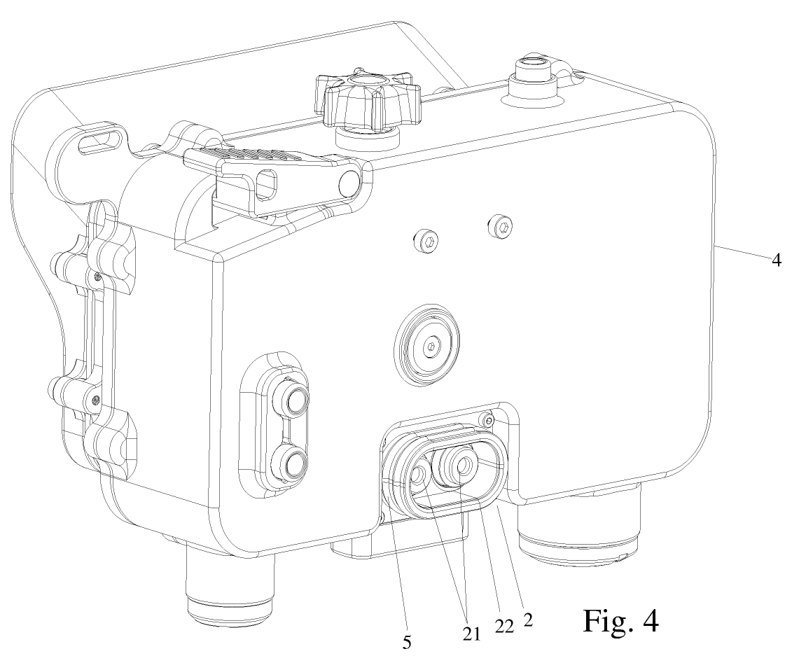

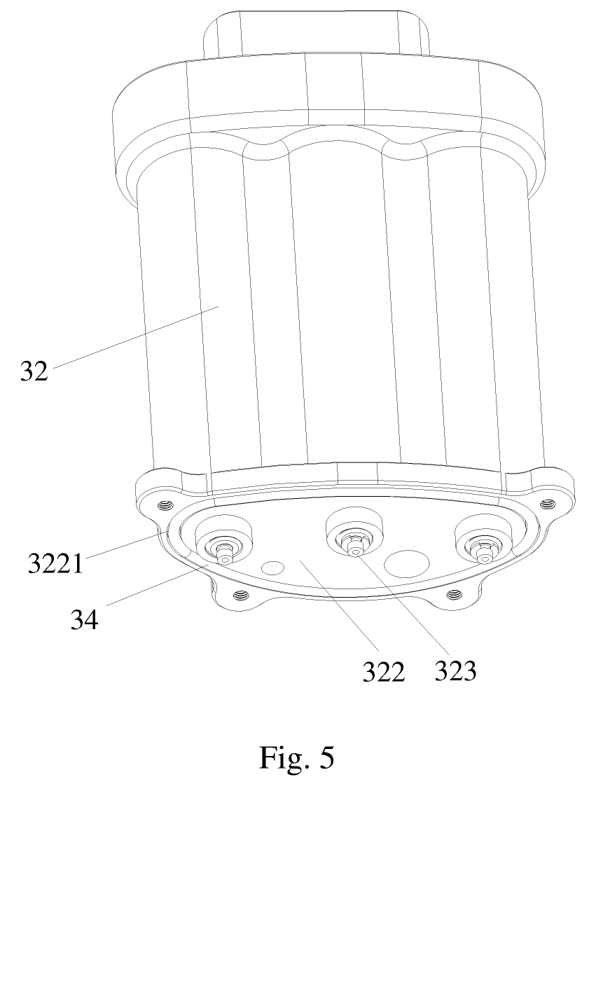

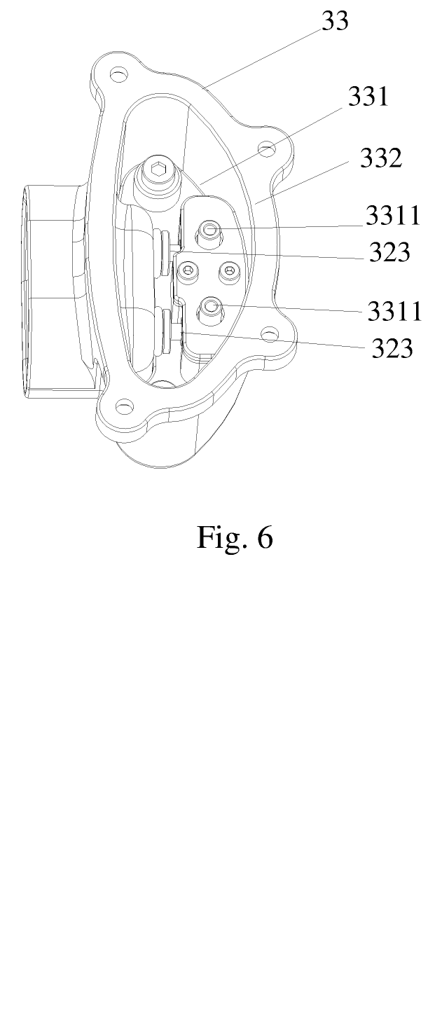

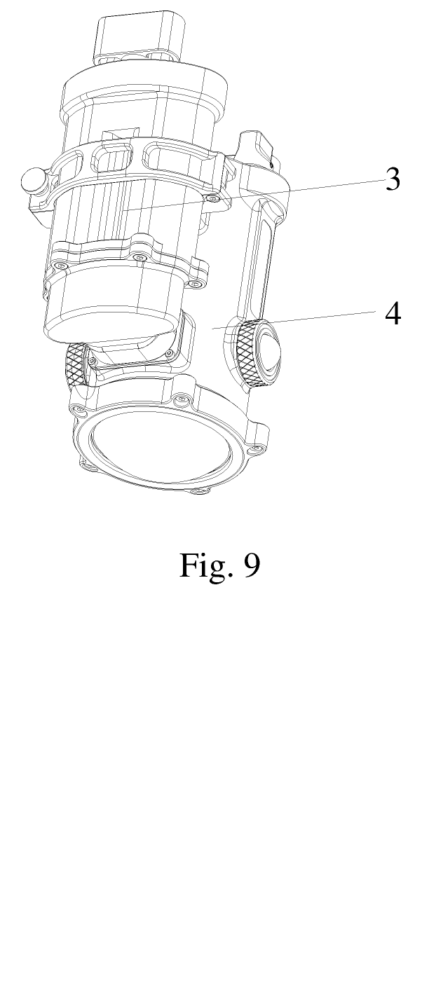

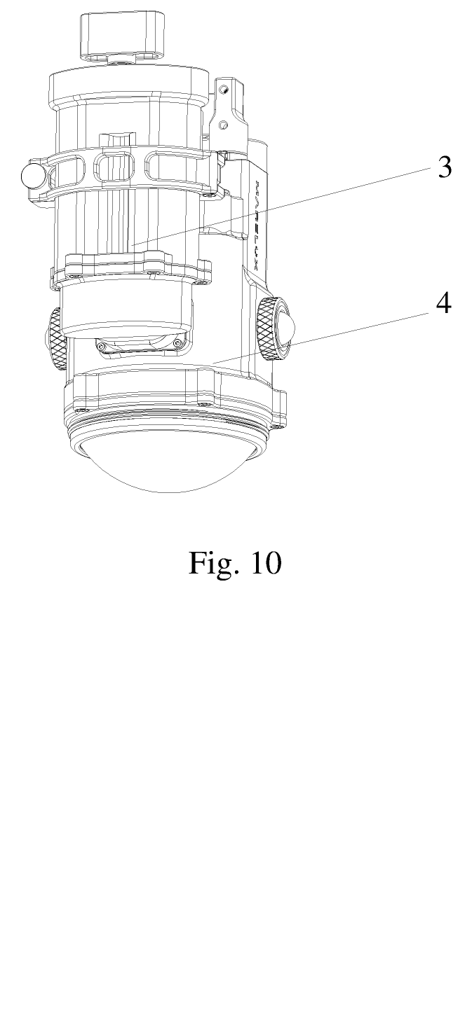

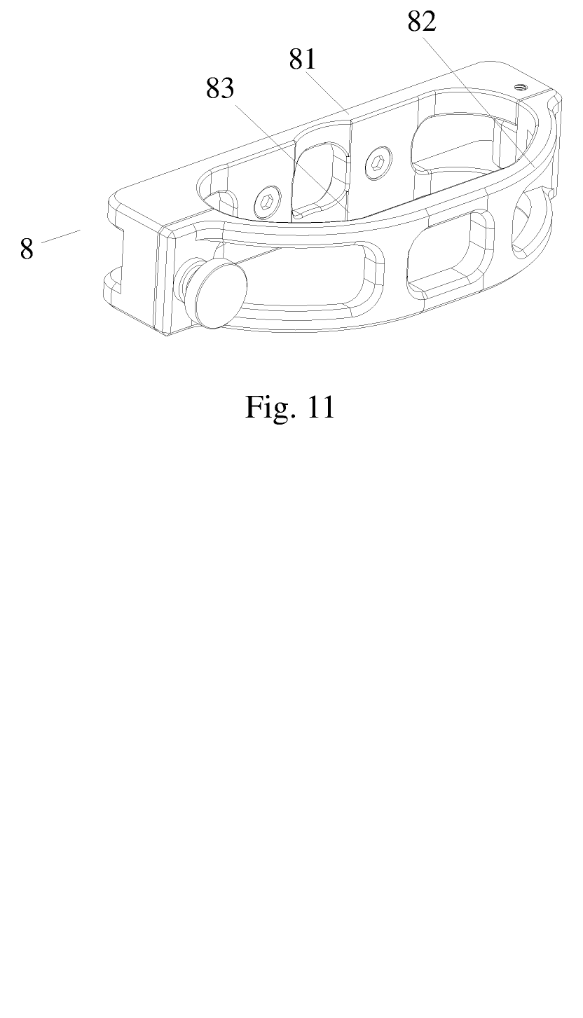

Referring to FIGS. 1-11, an underwater apparatus with a detachable battery compartment, which includes: a first connecting base 1, a second connecting base 2, a battery compartment mechanism 3, a functional apparatus 4 and a locking mechanism 8;

the first connecting base 1 is fixed on the battery compartment mechanism 3, and the first connecting base 1 is electrically connected to the battery compartment mechanism 3;

the second connecting base 2 is fixed on the functional apparatus 4, and the second connecting base 2 is electrically connected to the functional apparatus 4;

the battery compartment mechanism 3 is detachably provided outside the functional apparatus 4 via the locking mechanism 8, and the first connecting base 1 and the second connecting base 2 are detachably inserted so as to be waterproof while being electrically connected.

In the present embodiment, the first connecting base 1 includes a first connector 11 and an insulated first water barrier 12, the first connector 11 is fixedly provided on the battery compartment mechanism 3, the first connector 11 has one end protrude out of the battery compartment mechanism 3 to form a first connecting terminal 111 and the other end extend into the battery compartment mechanism 3 to form a first equipment terminal 112 electrically connected to the battery compartment mechanism 3, the first water barrier 12 is fixedly provided outside the battery compartment mechanism 3, and the first water barrier 12 surrounds the outside of the first connecting terminal 111, so that the first connecting terminal 111 is surrounded and shielded;

the second connecting base includes a second connector 21 and an insulated second water barrier 22, the second connector 21 is fixedly provided on the functional apparatus 4, the second connector 21 has one end protrude out of the functional apparatus 4 to form a second connecting terminal 211 and the other end extend into the functional apparatus 4 to form a second equipment terminal 212 electrically connected to the functional apparatus 4, the second water barrier 22 is fixedly provided outside the functional apparatus 4, and the second water barrier 22 surrounds the outside of the second connecting terminal 211, so that the second connecting terminal 211 is surrounded and shielded;

when the functional apparatus 4 is connected to the battery compartment mechanism 3, physical connection is completed via the locking mechanism 8, and at the same time, the first water barrier 12 of the first connecting base 1 is detachably sleeved outside the second water barrier 22 of the second connecting base 2, and the first connecting terminal 111 is detachably electrically connected to the second connecting terminal 211; after the electrical connection is completed via the first connecting base 1 and the second connecting base 2, the battery compartment mechanism 3 can successively pass through the first equipment terminal 112, the first connecting terminal 111, the second connecting terminal 211 and the second equipment terminal 212 so as to supply electric energy to the functional apparatus 4. In this process, the outsides of the first connecting terminal 111 and the second connecting terminal 211 of the electrical connection are covered together by the cooperation of the first water barrier 12 and the second water barrier 22, so as to form a two-fold waterproof structure; at the same time, the cooperation of the first water barrier 12 and the second water barrier 22 can also improve the structural stability when the battery compartment mechanism 3 and the functional apparatus 4 are connected. It is emphasized that in other implementations, the second water barrier 22 of the second connecting base 2 may be detachably sleeved outside the first water barrier 12 of the first connecting base 1 so as to complete the insertion and connection between the second connecting base 2 and the first connecting base 1.

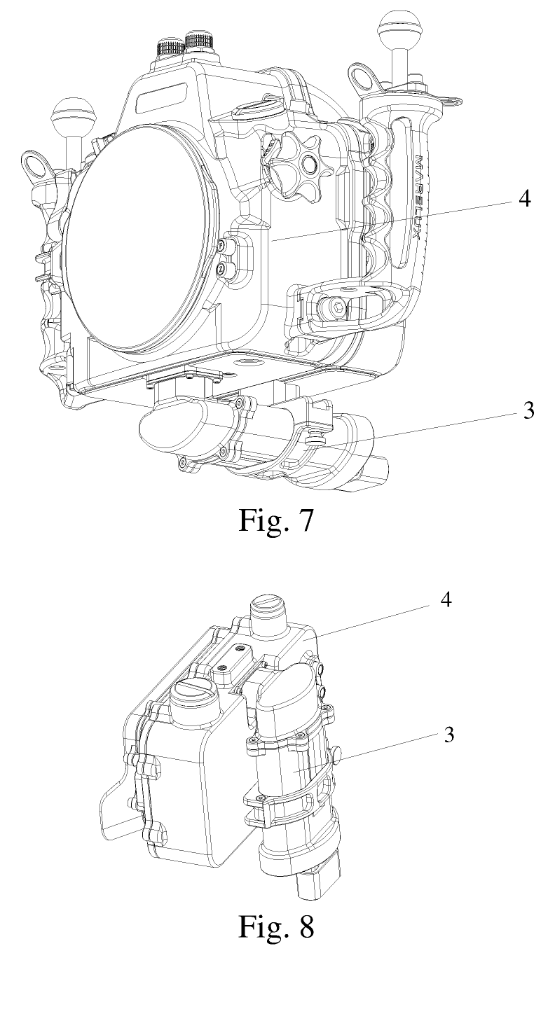

It should be noted that the functional apparatus 4 may be a variety of apparatuses that require electrical energy to achieve its function; referring to FIGS. 7-10, the functional apparatus 4 may be a flash light, a video light, a camera diving housing, a monitor body housing, etc.

In the present embodiment, the underwater apparatus further includes a first waterproof ring 5, the first waterproof ring 5 is sleeved outside the second water barrier 22, and the inside of the first water barrier 12 abuts against the first waterproof ring 5.

In the present embodiment, after the first connecting base 1 and the second connecting base 2 are connected, the end of the first water barrier 12 abuts against the outside of the functional apparatus 4 to further prevent external liquid from entering into the connection between the first connecting terminal 111 and the second connecting terminal 211.

In the present embodiment, a first waterproof groove 221 is provided around the outside of the second water barrier 22, and the first waterproof ring 5 is sleeved in the first waterproof groove 221 and protrudes outside the second water barrier 22, so as to ensure the stability of the first waterproof ring 5 on the second water barrier 22 and further improve the waterproof performance at the second water barrier.

In the present embodiment, the number of the first waterproof ring 5 and the first waterproof grooves 221 is plural, and the plurality of first waterproof rings 5 are respectively sleeved at the plurality of first waterproof grooves 221 outside of the second connector 21.

In the present embodiment, the first connecting base 1 further includes a first insulating sleeve 6, the battery compartment mechanism 3 is provided with a first mounting hole 31, the first connector 11 is provided in the first mounting hole 31, the first insulating sleeve 6 is sleeved inside and attached to the first connector 11, and the first insulating sleeve 6 is attached outside at a side face of the first mounting hole 31. In particular, the first insulating sleeve 6 is made of POM plastic.

In the present embodiment, a second waterproof groove 61 is provided outside the first insulating sleeve 6, and a second waterproof ring 62 is sleeved in the second waterproof groove 61, and the second waterproof ring 62 abuts against the side face of the first mounting hole 31. In particular, the number of the second waterproof grooves 61 and the second waterproof rings 62 may be one or more.

In the present embodiment, the first connector 11 is sleeved with a third waterproof ring 63, which abuts against the inside of the first insulating sleeve 6. In particular, the number of the third waterproof ring 63 may be one or more.

In the present embodiment, the first connector 11 is movably connected to the first insulating sleeve 6, a rebound chamber 64 is provided at one end of the first insulating sleeve 6 near the first connecting terminal 111, an abutting ring 113 is fixed outside the first connecting terminal 111, a first spring 65 is also provided in the rebound chamber 64, and the first spring 65 is sleeved at the first connecting terminal 111, and two ends of the first spring 65 abut against or are connected to the abutting ring 113 and the first insulating sleeve 6, respectively. Specifically, a movable piece 66 is also movably provided in the rebound chamber 64 and is sleeved on the first connecting terminal 111, and the two ends of the first spring 65 respectively abut against or are connected to the abutting ring 113 and the movable piece 66, where the movable piece 66 is pushed by the first spring 65 to abut against the bottom surface of the rebound chamber 64 of the first insulating sleeve 6. When the first connecting terminal 111 and the second connecting terminal 211 are connected, the second connecting terminal 211 can abut against and push the first connecting terminal 111 of the first connector 11, and at this time, the first connecting terminal 111 drives the abutting ring 113 to compress the first spring 65, and at the same time, retract inside the first insulating sleeve 6.

In the present embodiment, a trigger 3311 for electrically connecting the first equipment terminal 112 with the battery compartment mechanism 3 is provided in the battery compartment mechanism 3, where the movement of the first connector 11 on the first insulating sleeve 6 includes a triggered state in which the first equipment terminal 112 is pushed back to abut against the trigger 3311 when the second connecting terminal 211 abuts against the first connecting terminal 111, and a power-off state in which the first equipment terminal 112 is separated from the trigger 3311 under the resilience of the first spring 65 when the second connecting terminal 211 is disengaged from the first connecting terminal 111.

Specifically, when the first connecting base 1 is connected to the second connecting base 2, under the abut of the second connecting terminal 211, the first connecting terminal 111 will be pushed back. At this moment, the first spring 65 is compressed, and the first equipment terminal 112 is supported by the trigger 3311; the first connector 11 is in a triggered state; the battery compartment mechanism 3 is electrically connected to the functional apparatus via the trigger 3311, the first connector 11 and the second connector 21. When the first connecting base 1 is disengaged from the second connecting base 2, the first spring 65 rebounds, so that the first connector 11 is reset, the first equipment terminal 112 is separated from the trigger 3311, the first connector 11 is in a power-off state, and the first equipment terminal 112 is electrically disconnected from the battery compartment mechanism 3. At this time, even if the first connecting terminal of the first connecting base directly contacts with the liquid, the short circuit of the battery compartment mechanism will not be caused, which is safer and more reliable.

In the present embodiment, the second connecting base 2 further includes a second insulating sleeve 7, the functional apparatus 4 is provided with a second mounting hole 41, the second connector 21 is provided in the second mounting hole 41, the second insulating sleeve 7 is sleeved inside and attached to the second connector 21, and the second insulating sleeve 7 is attached outside at a side face of the second mounting hole 41. In particular, the second insulating sleeve 7 is made of POM plastic.

In the present embodiment, a third waterproof groove 71 is provided outside the second insulating sleeve 7, a fourth waterproof ring 72 is sleeved in the third waterproof groove 71 and abuts against the side face of the second mounting hole 41. In particular, the number of the third waterproof groove 71 and the fourth waterproof ring 72 may be one or more.

In the present embodiment, a fourth waterproof groove 213 is sleeved on the second connector 21, and a fifth waterproof ring 73 is sleeved in the fourth waterproof groove 213, and the fifth waterproof ring 73 abuts against the inner side of the second insulating sleeve 7. In particular, the number of the fourth waterproof groove 213 and the fifth waterproof ring 73 may be one or more.

In the present embodiment, the number of the first connectors 11 is plural, the number of the second connectors 21 is plural, and the plurality of the first connectors 11 are detachably electrically connected to the plurality of the second connectors 21, respectively.

In the present embodiment, the first waterproof ring 5, the second waterproof ring 62, the third waterproof ring 63, the fourth waterproof ring 72, and the fifth waterproof ring 73 are all O-shaped silicone rings.

In the present embodiment, the first connecting base 1 is bent and fixed at a lower end of the battery compartment mechanism 3, and a bending angle of the first connecting base 1 can be specifically ninety degrees, and the first connecting base 1 is parallel to the locking mechanism 8 after being bent; an upper end or a middle part of the battery compartment mechanism 3 is detachably provided outside the functional apparatus 4 via the locking mechanism.

In the present embodiment, the battery compartment mechanism 3 includes a battery compartment body 32 and a connecting base body 33, where a battery assembly 321 is provided in the battery compartment body 32, an electrical contact surface 322 is formed at the lower end of the battery compartment body 32, and a battery electrical contact terminal 323 electrically connected to the battery assembly 321 is provided at the electrical contact surface 322;

the connecting base body 33 is provided with an electrical contact slot 331, the first connector 11 and the first water barrier 12 are both fixedly provided on the connecting base body 33, the first connecting terminal 111 protrudes outside the connecting base body 33, and the first equipment terminal 112 extends into the electrical contact slot 331;

the connecting base body 33 is provided with an electrical contact port 332 which is connected to the electrical contact slot 331; the connecting base body 33 is detachably connected to the lower end of the battery compartment mechanism 3 via a screw structure; the electrical contact surface 322 abuts against the electrical contact port 332 so as to close the electrical contact port 332; and the first equipment terminal 112 is electrically connected to the battery electrical contact terminal 323 via the trigger 3311. Specifically, the trigger 3311 is specifically located in the wiring groove, and the trigger 3311 is electrically connected to the battery electrical contact terminal 323; when the first connector 11 is in the triggered state, the first equipment terminal 112 is electrically connected to the battery electrical contact terminal 323 via the trigger 3311; when the first connector 11 is in the power-off state, the first equipment terminal 112 is disengaged from the trigger 3311 and is thus electrically disconnected from the battery electrical contact terminal 323.

It needs to be emphasized that the battery assembly 321 specifically includes a structure such as a battery and a circuit board, and can be electrically connected to the first equipment terminal 112 via the battery electrical contact terminal 323, so that the first connecting base 1 can serve as a port for supplying electric energy to the functional apparatus 4; however, based on the structural design between the battery compartment body 32 and the connecting base body 33, the connecting base body 33 can be replaced by disassembling and replacing so as to replace the first connecting base of a type or size while ensuring that water does not easily enter into the electrical contact slot 331.

In the present embodiment, the battery compartment mechanism 3 further includes a sixth waterproof ring 34, the electrical contact surface 322 is provided with a fifth waterproof groove 3221, the sixth waterproof ring 34 is provided in the fifth waterproof groove 3221 so as to surround the battery electrical contact terminal 323, and the electrical contact port 332 abuts against the sixth waterproof ring 34.

In the present embodiment, the locking mechanism 8 includes a first locking member 81 fixedly provided outside the functional apparatus 4, and a second locking member 82, and a locking position for locking the battery compartment mechanism 3 is formed between the first locking member 81 and the second locking member 82.

In the present embodiment, the second locking member 82 has one end hinged to one end of the first locking member 81 and the other end detachably connected to the other end of the first locking member 81, and the locking position is a locking cavity 83 for surrounding the battery compartment mechanism 3;

the locking mechanism 8 locks the battery compartment mechanism 3 as follows: firstly, the other end of the first locking member 81 is separated from the second locking member 82, and then one end of the second locking member 82 is controlled to rotate around one end of the first locking member 81 so as to open the locking cavity 83; then the battery compartment mechanism 3 is placed in the locking cavity 83 between the first locking member 81 and the second locking member 82, and one end of the second locking member 82 is controlled to rotate in a reverse direction around one end of the first locking member 81, so that the other end of the first locking member 81 is close to the second locking member 82; finally, the other end of the first locking member 81 is locked with the second locking member 82 so as to lock and fix the battery compartment mechanism 3 in the locking cavity 83 by means of the cooperation of the first locking member 81 and the second locking member 82.

Specifically, the other end of the second locking member 82 is detachably connected to the other end of the first locking member 81 by a screw structure.

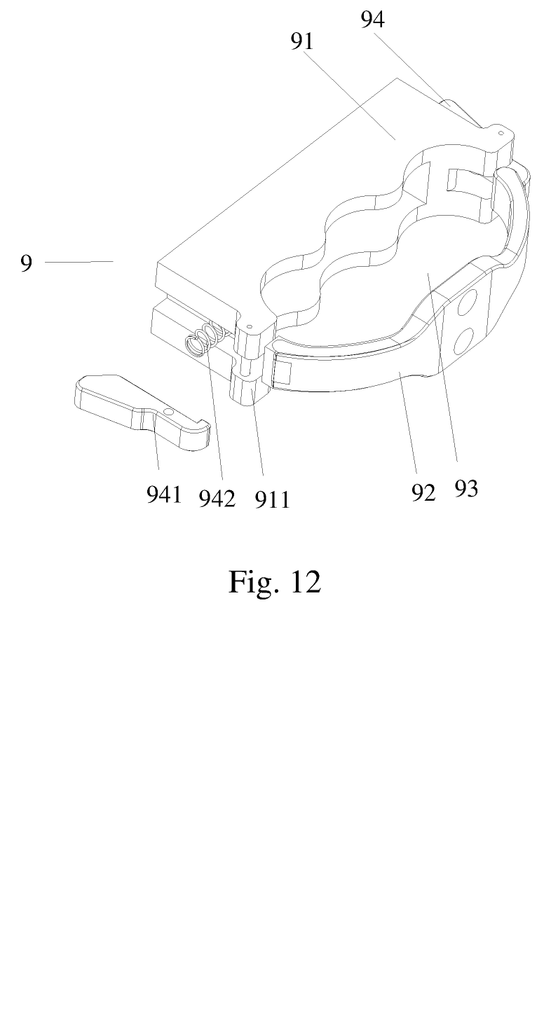

Referring to FIG. 12, the present application also provides a second embodiment, which differs from the first embodiment only in the replacement of the locking mechanism, and in particular, in the second embodiment:
the locking mechanism 9 includes a first locking member 91 and a second locking member 92, where the first locking member 91 is fixedly provided outside the functional apparatus 4, and a locking position for locking the battery compartment mechanism 3 is formed between the second locking member 92 and the first locking member 91.

One end of the second locking member 92 is detachably connected to one end of the first locking member 91, and the other end of the second locking member 92 is detachably connected to the other end of the first locking member 91, and the locking position is a locking cavity 93 for surrounding the battery compartment mechanism 3.

In the present embodiment, two ends of the first locking member 91 are provided with buckle assemblies 94, and two ends of the second locking member 92 are detachably connected to the buckle assemblies 94 at two ends of the first locking member 91, respectively. In other implementations, the two ends of the second locking member 92 may also be detachably attached to the second locking member 91 by screws.

In the present embodiment, the buckle assembly 94 includes a buckle member 941, a second spring 942, and two parallel buckle brackets 911 are provided at one end and the other end of the first locking member 91; the middle part of the buckle member 941 is hingedly provided between the two buckle brackets 911, one end of the second spring 942 is connected to the first locking member 91, and the other end of the second spring 942 is connected to one end of the buckle member 941; the other ends of the buckle members 941 of the two buckle assemblies 94 are respectively detachably snap-connected to the two ends of the second locking member 92. By pressing one end of the buckle member 941, the buckle member 941 is made to rotate around the middle part thereof and compress the second spring 942, and at this time, the other ends of the two buckle members 941 are relatively far apart so as to release the originally locked second locking member 92 or used for mounting the second locking member 92; one end of the buckle member 941 is released, and under the action of the second spring 942, the buckle member 941 is rotationally reset around the middle portion thereof, and at this time, the other ends of the two buckle members 941 are relatively close, so as to snap-lock the second locking member 92 located between the other ends of the two buckle members 941.

The above are only the preferred embodiments of the present application and are not intended to limit the invention, any modifications, equivalent replacements, and improvements made within the spirit and principles of the present application shall be included within the protection scope of the present application.

What is claimed is:

1. An underwater apparatus with a detachable battery compartment, comprising:
a battery compartment mechanism;
a functional apparatus;
a first connecting base fixed on the battery compartment mechanism and electrically connected to the battery compartment mechanism;
a second connecting base fixed on the functional apparatus and electrically connected to the functional apparatus; and
a locking mechanism, wherein the battery compartment mechanism is detachably provided outside the functional apparatus via the locking mechanism, and the first connecting base and the second connecting base are detachably electrically connected.

2. The underwater apparatus with a detachable battery compartment according to claim 1, wherein the locking mechanism comprises a first locking member and a second locking member, the first locking member is fixedly provided outside the functional apparatus, at least one end of the second locking member is detachably connected or movably connected to the first locking member, and a locking position for locking the battery compartment mechanism is formed between the second locking member and the first locking member.

3. The underwater apparatus with a detachable battery compartment according to claim 2, wherein the second locking member has one end hinged to one end of the first locking member and has the other end detachably connected to the other end of the first locking member, and the locking position is a locking cavity for surrounding the battery compartment mechanism;
or, the second locking member has one end detachably connected to one end of the first locking member and has the other end detachably connected to the other end of the first locking member, and the locking position is a locking cavity for surrounding the battery compartment mechanism.

4. The underwater apparatus with a detachable battery compartment according to claim 1, wherein the first connecting base is bent and fixed at a lower end of the battery compartment mechanism, and an upper end or a middle part of the battery compartment mechanism is detachably provided outside the functional apparatus via the locking mechanism.

5. The underwater apparatus with a detachable battery compartment according to claim 1, wherein the first connecting base comprises a first connector and an insulated first water barrier, the first connector is fixedly provided on the battery compartment mechanism, the first connector has one end protrude out of the battery compartment mechanism to form a first connecting terminal and the other end extend into the battery compartment mechanism to form a first equipment terminal electrically connected to the battery compartment mechanism, the first water barrier is fixedly provided outside the battery compartment mechanism, and the first water barrier surrounds the first connecting terminal;
the second connecting base comprises a second connector and an insulated second water barrier, and the second connector is fixedly provided on the functional apparatus, has one end protrude out of the functional apparatus to form a second connecting terminal and has the other end extend into the functional apparatus to form a second equipment terminal electrically connected to the functional apparatus, the second water barrier is fixedly provided outside the functional apparatus, and the second water barrier surrounds the second connecting terminal; and
the first water barrier is detachably sleeved outside the second water barrier, or the second water barrier is detachably sleeved outside the first water barrier; and the first connecting terminal is detachably and electrically connected to the second connecting terminal.

6. The underwater apparatus with a detachable battery compartment according to claim 5, further comprising a first waterproof ring provided between the first water barrier and the second water barrier.

7. The underwater apparatus with a detachable battery compartment according to claim 5, wherein the first connecting base further comprises a first insulating sleeve, the battery compartment mechanism is provided with a first mounting hole into which the first connector is provided, the first insulating sleeve is sleeved inside and attached to the first connector, and the first insulating sleeve is attached outside at a side face of the first mounting hole;
a second waterproof groove is provided outside the first insulating sleeve, a second waterproof ring is sleeved in the second waterproof groove, and the second waterproof ring abuts against a side face of the first mounting hole; and
a third waterproof ring is sleeved on the first connector and abuts against an inner side of the first insulating sleeve.

8. The underwater apparatus with a detachable battery compartment according to claim 7, wherein the first connector is movably connected to the first insulating sleeve, a rebound chamber is provided at one end of the first insulating sleeve close to the first connecting terminal, a first abutting ring is fixed outside the first connecting terminal, a first spring is also provided in the rebound chamber and is sleeved at the first connecting terminal, and two ends of the first spring respectively abut against or are connected to the first abutting ring and the first insulating sleeve; and
a trigger for electrically connecting the first equipment terminal with the battery compartment mechanism is further provided in the battery compartment mechanism, wherein the movement of the first connector on the first insulating sleeve comprises a triggered state in which the first equipment terminal is pushed back to abut against the trigger when the second connecting terminal abuts against the first connecting terminal, and a power-off state in which the first equipment terminal is separated from the trigger under the resilience of the first spring when the second connecting terminal is disengaged from the first connecting terminal.

9. The underwater apparatus with a detachable battery compartment according to claim 5, wherein the second connecting base further comprises a second insulating sleeve, the functional apparatus is provided with a second mounting hole into which the second connector is provided, the second insulating sleeve is sleeved inside and attached to the second connector, and the second insulating sleeve is attached outside at a side face of the second mounting hole;
a third waterproof groove is provided outside the second insulating sleeve, a fourth waterproof ring is sleeved in the third waterproof groove, and the fourth waterproof ring abuts against the side face of the second mounting hole; and
a fourth waterproof groove is sleeved on the second connector, a fifth waterproof ring is sleeved in the fourth waterproof groove, and the fifth waterproof ring abuts against an inner side of the second insulating sleeve.

10. The underwater apparatus with a detachable battery compartment according to claim 5, wherein the battery compartment mechanism comprises a battery compartment body and a connecting base body, a battery assembly is provided in the battery compartment body, an electrical contact surface is formed at a lower end of the battery compartment body, and a battery electrical contact terminal electrically connected to the battery assembly is provided at the electrical contact surface;
the connecting base body is provided with an electrical contact slot, the first connector and the first water barrier are both fixedly provided on the connecting base body, the first connecting terminal protrudes outside the connecting base body, and the first equipment terminal extends into the electrical contact slot; and
the connecting base body is provided with an electrical contact port connected to the electrical contact slot, the connecting base body is detachably connected to the lower end of the battery compartment mechanism, the electrical contact surface abuts against the electrical contact port so as to close the electrical contact port, and the first equipment terminal is electrically connected to the battery electrical contact terminal.

11. The underwater apparatus with a detachable battery compartment according to claim 2, wherein the first connecting base comprises a first connector and an insulated first water barrier, the first connector is fixedly provided on the battery compartment mechanism, the first connector has one end protrude out of the battery compartment mechanism to form a first connecting terminal and the other end extend into the battery compartment mechanism to form a first equipment terminal electrically connected to the battery compartment mechanism, the first water barrier is fixedly provided outside the battery compartment mechanism, and the first water barrier surrounds the first connecting terminal;
the second connecting base comprises a second connector and an insulated second water barrier, and the second connector is fixedly provided on the functional apparatus, has one end protrude out of the functional apparatus to form a second connecting terminal and has the other end extend into the functional apparatus to form a second equipment terminal electrically connected to the functional apparatus, the second water barrier is fixedly provided outside the functional apparatus, and the second water barrier surrounds the second connecting terminal; and
the first water barrier is detachably sleeved outside the second water barrier, or the second water barrier is detachably sleeved outside the first water barrier; and the first connecting terminal is detachably and electrically connected to the second connecting terminal.

12. The underwater apparatus with a detachable battery compartment according to claim 11, further comprising a first waterproof ring provided between the first water barrier and the second water barrier.

13. The underwater apparatus with a detachable battery compartment according to claim 11, wherein the first connecting base further comprises a first insulating sleeve, the battery compartment mechanism is provided with a first mounting hole into which the first connector is provided, the first insulating sleeve is sleeved inside and attached to the first connector, and the first insulating sleeve is attached outside at a side face of the first mounting hole;
a second waterproof groove is provided outside the first insulating sleeve, a second waterproof ring is sleeved in the second waterproof groove, and the second waterproof ring abuts against a side face of the first mounting hole; and
a third waterproof ring is sleeved on the first connector and abuts against an inner side of the first insulating sleeve.

14. The underwater apparatus with a detachable battery compartment according to claim 13, wherein the first connector is movably connected to the first insulating sleeve, a rebound chamber is provided at one end of the first insulating sleeve close to the first connecting terminal, a first abutting ring is fixed outside the first connecting terminal, a first spring is also provided in the rebound chamber and is sleeved at the first connecting terminal, and two ends of the first spring respectively abut against or are connected to the first abutting ring and the first insulating sleeve; and
a trigger for electrically connecting the first equipment terminal with the battery compartment mechanism is further provided in the battery compartment mechanism, wherein the movement of the first connector on the first insulating sleeve comprises a triggered state in which the first equipment terminal is pushed back to abut against the trigger when the second connecting terminal abuts against the first connecting terminal, and a power-off state in which the first equipment terminal is separated from the trigger under the resilience of the first spring when the second connecting terminal is disengaged from the first connecting terminal.

15. The underwater apparatus with a detachable battery compartment according to claim 11, wherein the second connecting base further comprises a second insulating sleeve, the functional apparatus is provided with a second mounting hole into which the second connector is provided, the second insulating sleeve is sleeved inside and attached to the second connector, and the second insulating sleeve is attached outside at a side face of the second mounting hole;
a third waterproof groove is provided outside the second insulating sleeve, a fourth waterproof ring is sleeved in the third waterproof groove, and the fourth waterproof ring abuts against the side face of the second mounting hole; and
a fourth waterproof groove is sleeved on the second connector, a fifth waterproof ring is sleeved in the fourth waterproof groove, and the fifth waterproof ring abuts against an inner side of the second insulating sleeve.

16. The underwater apparatus with a detachable battery compartment according to claim 11, wherein the battery compartment mechanism comprises a battery compartment body and a connecting base body, a battery assembly is provided in the battery compartment body, an electrical contact surface is formed at a lower end of the battery compartment body, and a battery electrical contact terminal electrically connected to the battery assembly is provided at the electrical contact surface;
the connecting base body is provided with an electrical contact slot, the first connector and the first water barrier are both fixedly provided on the connecting base body, the first connecting terminal protrudes outside the connecting base body, and the first equipment terminal extends into the electrical contact slot; and
the connecting base body is provided with an electrical contact port connected to the electrical contact slot, the connecting base body is detachably connected to the lower end of the battery compartment mechanism, the electrical contact surface abuts against the electrical contact port so as to close the electrical contact port, and the first equipment terminal is electrically connected to the battery electrical contact terminal.

17. The underwater apparatus with a detachable battery compartment according to claim 3, wherein the first connecting base comprises a first connector and an insulated first water barrier, the first connector is fixedly provided on the battery compartment mechanism, the first connector has one end protrude out of the battery compartment mechanism to form a first connecting terminal and the other end extend into the battery compartment mechanism to form a first equipment terminal electrically connected to the battery compartment mechanism, the first water barrier is fixedly provided outside the battery compartment mechanism, and the first water barrier surrounds the first connecting terminal;
the second connecting base comprises a second connector and an insulated second water barrier, and the second connector is fixedly provided on the functional apparatus, has one end protrude out of the functional apparatus to form a second connecting terminal and has the other end extend into the functional apparatus to form a second equipment terminal electrically connected to the functional apparatus, the second water barrier is fixedly provided outside the functional apparatus, and the second water barrier surrounds the second connecting terminal; and
the first water barrier is detachably sleeved outside the second water barrier, or the second water barrier is detachably sleeved outside the first water barrier; and the first connecting terminal is detachably and electrically connected to the second connecting terminal.

18. The underwater apparatus with a detachable battery compartment according to claim 17, further comprising a first waterproof ring provided between the first water barrier and the second water barrier.

19. The underwater apparatus with a detachable battery compartment according to claim 17, wherein the first connecting base further comprises a first insulating sleeve, the battery compartment mechanism is provided with a first mounting hole into which the first connector is provided, the first insulating sleeve is sleeved inside and attached to the first connector, and the first insulating sleeve is attached outside at a side face of the first mounting hole;
a second waterproof groove is provided outside the first insulating sleeve, a second waterproof ring is sleeved in the second waterproof groove, and the second waterproof ring abuts against a side face of the first mounting hole; and
a third waterproof ring is sleeved on the first connector and abuts against an inner side of the first insulating sleeve.

20. The underwater apparatus with a detachable battery compartment according to claim 19, wherein the first connector is movably connected to the first insulating sleeve, a rebound chamber is provided at one end of the first insulating sleeve close to the first connecting terminal, a first abutting ring is fixed outside the first connecting terminal, a first spring is also provided in the rebound chamber and is sleeved at the first connecting terminal, and two ends of the first spring respectively abut against or are connected to the first abutting ring and the first insulating sleeve; and
a trigger for electrically connecting the first equipment terminal with the battery compartment mechanism is further provided in the battery compartment mechanism, wherein the movement of the first connector on the first insulating sleeve comprises a triggered state in which the first equipment terminal is pushed back to abut against the trigger when the second connecting terminal abuts against the first connecting terminal, and a power-off state in which the first equipment terminal is separated from the trigger under the resilience of the first spring when the second connecting terminal is disengaged from the first connecting terminal.
